(19) United States
(12) Patent Application Publication
(10) Pub. No.: US 2026/0236108 A1
(43) Pub. Date: Aug. 13, 2026

(54) FOOT STAND STRUCTURE AND KEYBOARD USING THE SAME

(71) Applicant: Darfon Electronics Corp., Taoyuan City (TW)

(72) Inventors: Yu-Chun HSIEH, Taoyuan City (TW); Chen YANG, Taoyuan City (TW); Chun-Hua CHANG, Taoyuan City (TW)

(73) Assignee: Darfon Electronics Corp., Taoyuan City (TW)

(21) Appl. No.: 19/301,892

(22) Filed: Aug. 15, 2025

(30) Foreign Application Priority Data
Feb. 7, 2025 (TW) 114104568

(51) Int. Cl. G06F 3/02

(52) U.S. Cl. CPC G06F 3/0208

(57) ABSTRACT

A foot stand structure includes a first support portion, a first sliding portion and a compressible/stretchable member. The first support portion includes a first support member and a first rotation shaft protruding outward from opposite ends of the first support member. The first rotation shaft is sleeved in pivot holes of a base so that the first support portion can rotate relative to the base to an open position. The first support member has a first slot and a first fixing member disposed in the first slot. The first sliding portion includes a sliding member and a first abutting member protruding outward from one end of the sliding member. The sliding member is disposed in the first slot, and the sliding member is retractable relative to the first support member by the compressible/stretchable member.

This application claims the benefit of Taiwan application Serial No. 114104568, filed Feb. 7, 2025, the subject matter of which is incorporated herein by reference.

### BACKGROUND OF THE INVENTION

### Field of the Invention

The invention relates in general to a foot stand, and more particularly to a foot stand structure and a keyboard using the same.

### Description of the Related Art

In addition to assisting in placing the keyboard base on a desktop, a typical keyboard stand also serves to absorb the impact force generated when a user presses a key downward, thereby providing a buffering and noise reduction effect. For example, when a key is pressed and makes vibration waves transmit to the keyboard base, the noise generated by the vibration waves being transmitted to the keyboard base is typically reduced solely by using foot pads mounted on the stand. However, typical foot pads are relatively rigid, and their material can only be compressed to a limited distance (e.g., less than 1 mm). Therefore, when the entire keyboard base needs to move up and down a large distance (e.g., greater than 1 mm) in response to an impact force, the foot pads of the keyboard stand cannot provide a softer buffering effect, and thus cannot achieve a soft and bouncy pressing feel.

### SUMMARY OF THE INVENTION

The present invention relates to a foot stand structure and a keyboard using the foot stand structure for providing buffering and noise reduction effects.

According to one aspect of the present invention, a keyboard is provided. The keyboard includes a keyboard base and a foot stand structure. A first mounting slot is provided on a lower surface of the keyboard base. The foot stand structure includes a first support portion, a first sliding portion, and a compressible/stretchable member. The first support portion includes a first support member and a first rotation shaft protruding outwardly from opposite ends of the first support member. First pivot holes are recessed inwardly on opposite sides of the first mounting slot. The first rotation shaft is sleeved in the first pivot holes, so that the first support portion is accommodated in the first mounting slot and can rotate relative to the keyboard base to an open position. The first support member has a first slot and a first fixing member disposed within the first slot. The first sliding portion includes a sliding member and a first abutting member protruding outward from one end of the sliding member. The first fixing member is disposed opposite the first abutting member, and the compressible/stretchable member is disposed between the first fixing member and the first abutting member. The sliding member is disposed in the first slot and is retractable relative to the first support member by the compressible/stretchable member.

According to one aspect of the present invention, a foot stand structure is provided. The foot stand structure includes a first support portion, a first sliding portion, and a compressible/stretchable member. The first support portion includes a first support member and a first rotational shaft protruding outward from opposite ends of the first support member. The first rotational shaft is sleeved in pivot holes of a base, enabling the first support member to rotate relative to the base to an open position. The first support member has a first slot and a first fixing member disposed within the first slot. The first sliding portion includes a sliding member and a first abutting member protruding outward from one end of the sliding member. The first fixing member is disposed opposite the first fastening member, and the compressible/stretchable member is disposed between the first fixing member and the first abutting member. The sliding member is disposed in the first slot and is retractable relative to the first support member by the compressible/stretchable member.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A to 1C respectively illustrate a front view, a bottom view, and a cross-sectional view along line A-A of a keyboard according to an embodiment of the present invention.

FIGS. 2A to 2C respectively illustrate assembled views of a foot stand structure in an uncompressed and compressed state, and an exploded view of the components thereof according to an embodiment of the present invention.

FIGS. 3A to 3C respectively illustrate assembled views of a foot stand structure in an uncompressed and compressed state, and an exploded view of the components thereof according to another embodiment of the present invention.

FIGS. 4A to 4C respectively illustrate assembled views of a foot stand structure in an uncompressed and compressed state, and an exploded view of the components thereof according to another embodiment of the present invention.

FIGS. 5 and 6 respectively illustrate a side view of a keyboard according to an embodiment of the present invention.

FIGS. 7A and 7B respectively illustrate a simplified schematic view and a cross-sectional view of a keyboard according to another embodiment of the present invention.

### DETAILED DESCRIPTION OF THE INVENTION

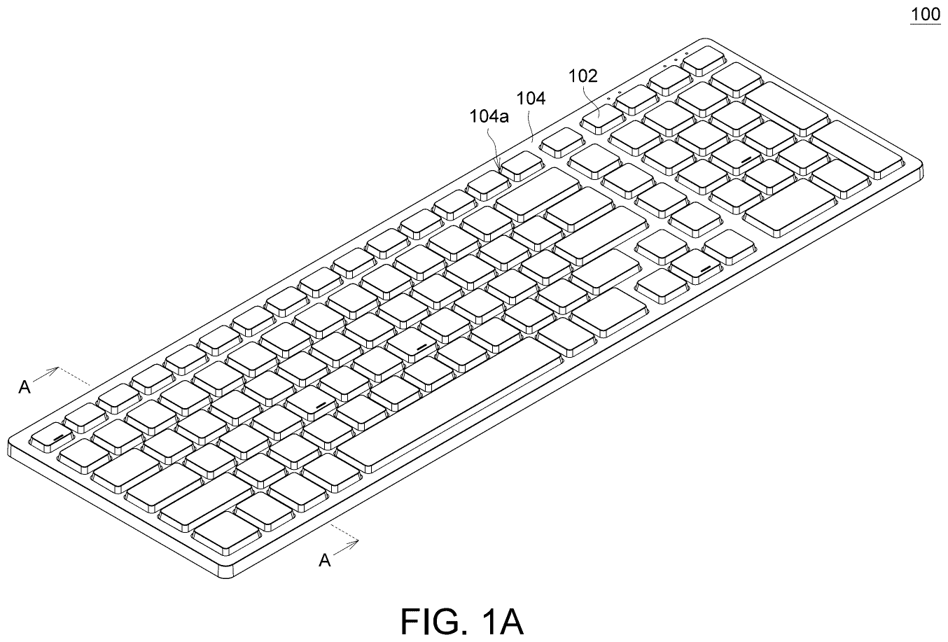

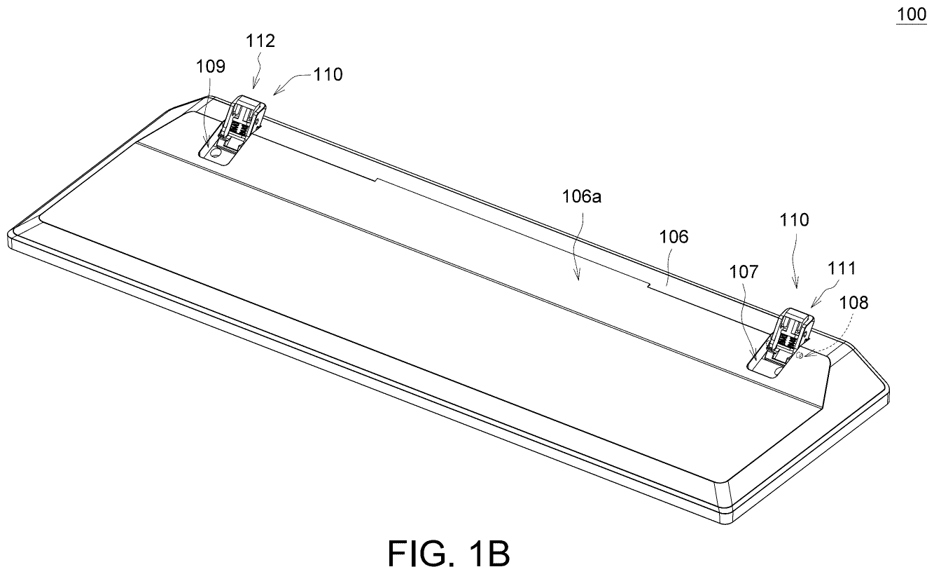

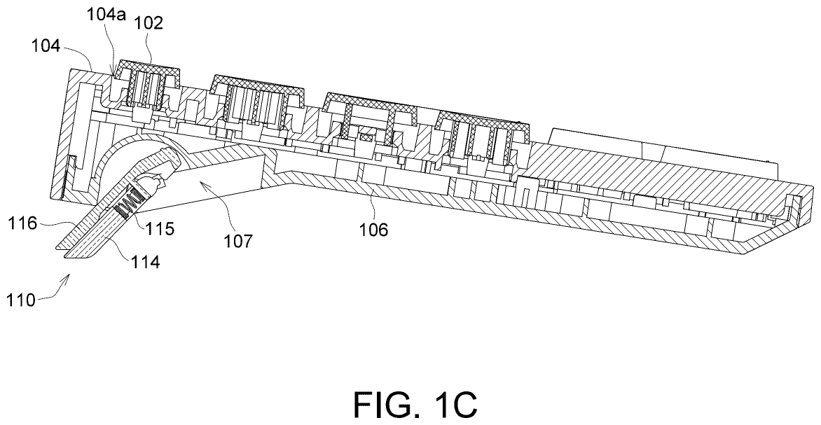

FIGS. 1A to 1C, a front view, a bottom view, and a cross-sectional view along line A-A of a keyboard 100 according to an embodiment of the present invention are respectively illustrated. As shown in the front view and the cross-sectional view, the keyboard 100 may include a plurality of keys 102, a keyboard cover 104, a keyboard base 106, and a foot stand structure 110. The keyboard cover 104 covers the keyboard base 106. The keyboard cover 104 includes a plurality of key openings 104a, each of the key openings 104a has an opening for each key 102 to move up and down relative to the keyboard base 106. The keyboard base 106 supports the keys 102 and an elastic body (not shown) and a membrane switch element (not shown) located below each of the keys 102. When one of the keys 102 is pressed and moves downward, the elastic body (not shown) located below one of the key 102 can trigger one of the membrane switch elements (not shown) to generate a press signal.

Referring to FIG. 1B, the lower surface 119d of the keyboard base 106 is provided with a first mounting slot 107 and a second mounting slot 109. The number of mounting slots may include, but is not limited to, two. A foot stand structure 110 is disposed on the lower surface 106a of the keyboard base 106. The foot stand structure 110 may include a first foot stand 111 and a second foot stand 112. The first foot stand 111 is mounted in the first mounting slot 107, and the second foot stand 112 is mounted in the second mounting slot 109. The number of foot stands may include, but is not limited to, two. Since the internal structures of each foot stand are identical, the following embodiment only describes one of stands.

In FIG. 1B, first pivot holes 108 are recessed inwardly on opposite sides of the first mounting slot 107. The foot stand structure 110 can be mounted in the first mounting slot 107 via the first pivot holes 108 and can be rotated relative to the keyboard base 106 to an open position to support the keyboard 100.

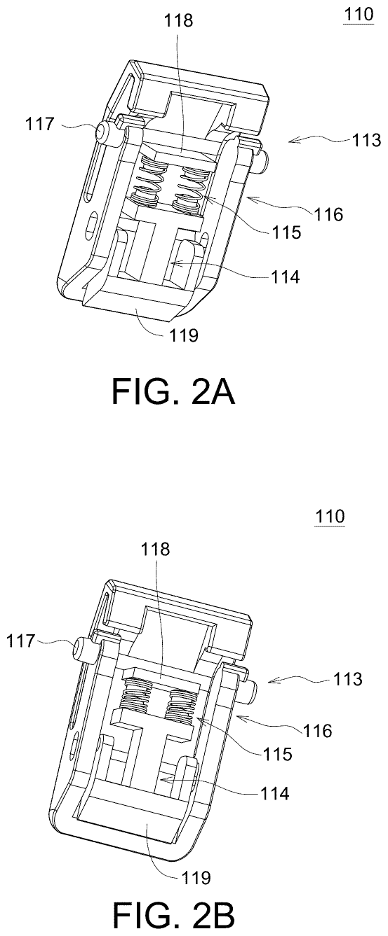

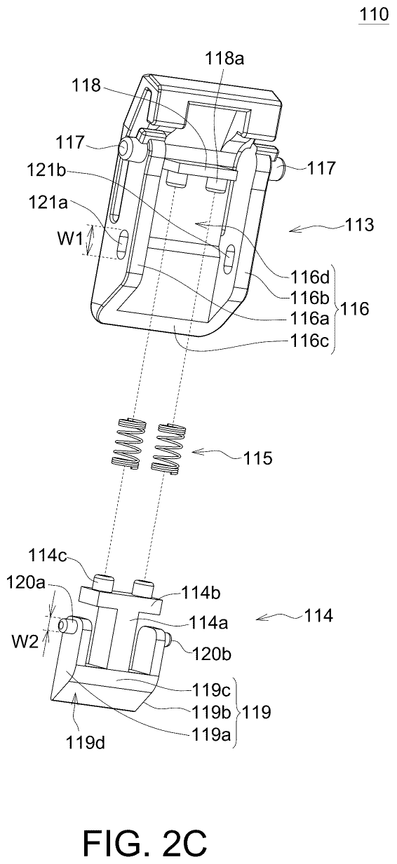

Referring to FIG. 2A to FIG. 2C, assembled views of the foot stand structure 110 in an uncompressed and compressed state, and an exploded view of components thereof according to one embodiment of the present invention are respectively illustrated. The foot stand structure 110 includes a first support portion 113, a first sliding portion 114, and a compressible/stretchable member 115. The compressible/stretchable member 115 may include, but is not limited to, two compression springs. The compressible/stretchable member 115 abuts between the first support portion 113 and the first sliding portion 114. In FIG. 2A, when the compressible/stretchable member 115 is unstressed, the compressible/stretchable member 115 is in a stretched state; while in FIG. 2B, when the compressible/stretchable member 115 is under stress, the compressible/stretchable member 115 is in a compressed state.

Referring to FIG. 2C, the first support portion 113 includes a first support member 116 and a first rotation shaft 117 protruding outward from opposite ends of the first support member 116. The first rotation shaft 117 can be inserted into the first pivot holes 108 shown in FIG. 1B, so that the first support portion 113 is accommodated in the first mounting slot 107 shown in FIG. 1B and can be rotated relative to the keyboard base 106 to an open position. In one embodiment, when the keyboard 100 is not supported by the foot stand structures 110, the foot stand structures 110 can be folded and stored in the first mounting slot 107 and the second mounting slot 109, respectively.

Referring to FIG. 2C, the first support member 116 has a first slot 116d and a first fixing member 118 disposed within the first slot 116d. The first support member 116, for example, has a U-shaped structure defined by three inner walls of a first outer plate 116a, a second outer plate 116b, and a lower plate 116c to form the first slot 116d. The first fixing member 118 may be disposed on the lower plate 116c and is substantially perpendicular to the lower plate 116c. In this embodiment, the first fixing member 118 is located near the pivot end (upper end) of the first support member 116 adjacent to the first rotation shaft 117 and away from the free end (lower end) of the first support member 116. The free end herein refers to the end of the first support member 116 that protrudes from the keyboard base 106 upon rotation relative to the first mounting slot 107 to support the keyboard 100 on the desktop, and is therefore also referred to as the supporting end.

In one embodiment, the first fixing member 118 has, for example, two protrusions 118a, and each of the protrusions 118a allows one end of the compressible/stretchable member 115 to be mounted on one of the protrusions 118a.

Referring to FIG. 2C, the first sliding portion 114 includes a sliding member 114a and a first abutting member 114b protruding outward from one end of the sliding member 114a. The first abutting member 114b has, for example, two protrusions 114c, and each of the protrusions 114c allows the other end of the compressible/stretchable member 115 to be mounted on one of the protrusions 114c.

Furthermore, the first sliding member 114 may further include a foot pad 119 located at the other end of the sliding member 114a. The foot pad 119, for example, has a U-shaped structure defined by three inner walls of a first inner plate 119a, a second inner plate 119b, and a bottom plate 119c. The sliding member 114a may be disposed on the bottom plate 119c and substantially perpendicular to the bottom plate 119c. In FIG. 2A, when the compressible/stretchable member 115 is unstressed, the foot pad 119 can protrude below the free end of the first support member 116 to provide the required support for the keyboard 100. In FIG. 2B, when the compressible/stretchable member 115 is stressed, the foot pad 119 can retract inward and be accommodated in the first slot 116d of the first support member 116 to provide the required buffering for the keyboard 100.

Referring to FIG. 2C, the first inner plate 119a includes a first stopper 120a, and the second inner plate 119b includes a second stopper 120b. The first and second stoppers 120a and 120b protrude from opposite sides of the first inner plate 119a and the second inner plate 119b, respectively. Furthermore, the first outer plate 116a includes a first limiting hole 121a, and the second outer plate 116b includes a second limiting hole 121b. The first limiting hole 121a passes through the first outer plate 116a and is axially compatible with the first stopper 120a, allowing the first stopper 120a to be inserted into the first limiting hole 121a. Furthermore, the second limiting hole 121b passes through the second outer plate 116b and is axially compatible with the second stopper 120b, allowing the second stopper 120b to be inserted into the second limiting hole 121b.

Referring to FIGS. 2A to 2C, the first limiting hole 121a and the second limiting hole 121b have a first dimension W1 in the sliding direction of the first sliding portion 114, while the first stopper 120a and the second stopper 120b have a second dimension W2 in the sliding direction of the first sliding portion 114. The second dimension W2 is smaller than the first dimension W1, for example, the second dimension W2 is approximately half of the first dimension W1, or another suitable ratio. Therefore, the first stopper 120a and the second stopper 120b can move within the first limiting hole 121a and the second limiting hole 121b, respectively, allowing the sliding member 114a to be retracted and retained relative to the first support member 116 through the cooperation of the compressible/stretchable member 115 and the aforementioned limiting structure, thereby increasing the buffering stroke of the foot pad 119.

In one embodiment, the foot pad 119, through the aforementioned compressible/stretchable member 115, provides a back-and-forth buffering stroke greater than 1 mm, for example, between 1 mm and 2 mm. Compared to conventional foot pads, which are relatively hard and have a limited compressible stroke, the foot stand structure 110 of this embodiment can provide a softer buffering effect and a greater buffering stroke when the entire keyboard base 106 needs to move up and down a larger stroke (for example, greater than 1 mm) in response to an impact force, thereby achieving a soft and pressing feel.

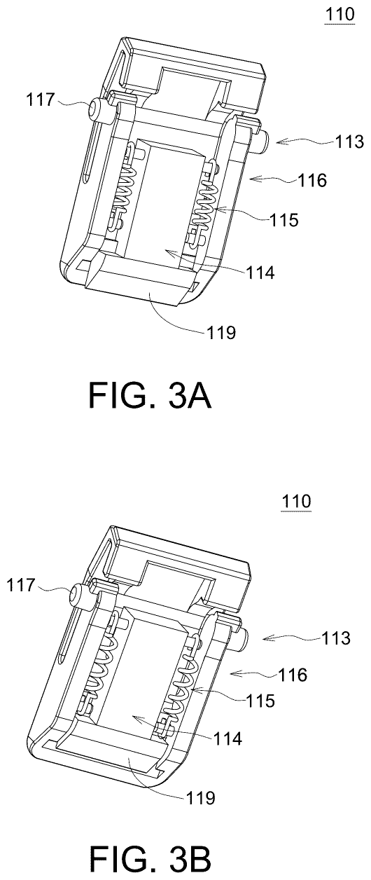

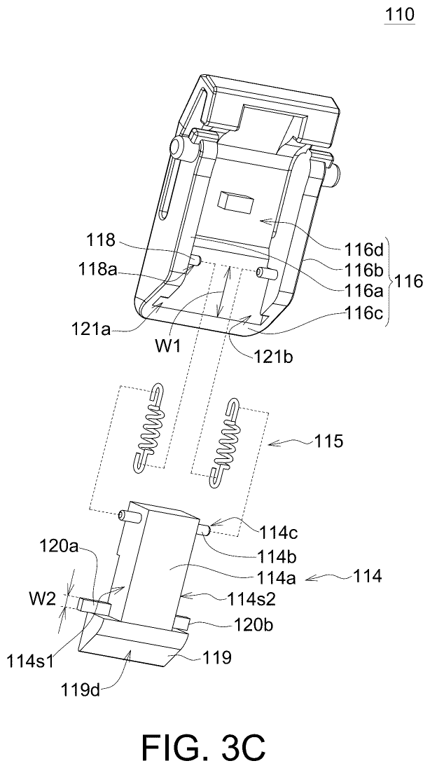

Referring to FIGS. 3A to 3C, assembled views of the foot stand structure 110 in an uncompressed and compressed state, as well as an exploded schematic view of the components thereof according to one embodiment of the present invention are respectively illustrated. The foot stand structure 110 includes a first support portion 113, a first sliding portion 114, and a compressible/stretchable member 115. The compressible/stretchable member 115 may include, but is not limited to, two tension springs. The compressible/stretchable member 115 abuts between the first support portion 113 and the first sliding portion 114. In FIG. 3A, when the compressible/stretchable member 115 is unstressed, the compressible/stretchable member 115 is in a compressed state; while in FIG. 3B, when the compressible/stretchable member 115 is under stress, the compressible/stretchable member 115 is in a stretched state.

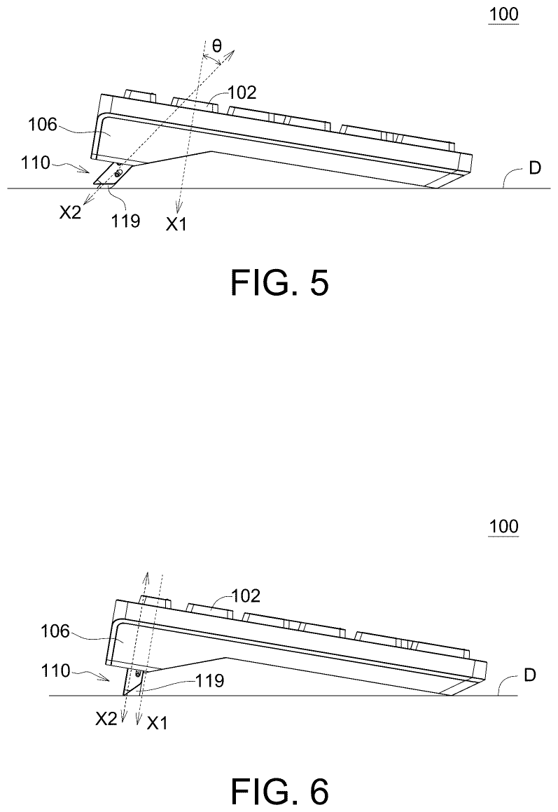

Referring to FIG. 3C, the first support portion 113 includes a first support member 116 and a first rotation shaft 117 protruding outward from opposite ends of the first support member 116. The first rotation shaft 117 can be inserted into the first pivot holes 108 shown in FIG. 1B, so that the first support portion 113 is accommodated in the first mounting slot 107 shown in FIG. 1B and can be rotated relative to the keyboard base 106 to an open position (as shown in FIG. 5) . In one embodiment, when the keyboard 100 is not supported by the foot stand structures 110, the foot stand structures 110 can be folded and stored in the first mounting slot 107 and the second mounting slot 109, respectively.

Referring to FIG. 3C, the first support member 116 has a first slot 116d and a first fixing member 118 disposed within the first slot 116d. The first support member 116, for example, has a U-shaped structure, including the first slot 116d defined by three inner walls of the U-shaped structure: a first outer plate 116a, a second outer plate 116b, and a lower plate 116c. The first fixing member 118 is, for example, disposed on opposite sides of the first outer plate 116a and the second outer plate 116b respectively and is substantially perpendicular to the inner walls thereof. In this embodiment, the first fixing member 118 is located near the free end (lower end) of the first support member 116 and away from the pivot end (upper end) of the first support member 116. The free end herein refers to the end of the first support member 116 that protrudes from the keyboard base 106 after rotation relative to the first mounting slot 107 to support the keyboard 100 on the desktop, and is therefore also referred to as the supporting end.

In one embodiment, the first fixing member 118 includes, for example, two protrusions 118a, for allowing one end of the compressible/stretchable member 115 to be sleeved onto one of the protrusions 118a.

Referring to FIG. 3C, the first sliding portion 114 includes a sliding member 114a and a first abutting member 114b protruding outward from one end of the sliding member 114a. The first abutting member 114b includes, for example, two protrusions 114c, for allowing the other end of the compressible/stretchable member 115 to be sleeved onto one of the protrusions 114c.

Furthermore, the first sliding portion 114 may further include a foot pad 119 located at the other end of the sliding member 114a. The foot pad 119 may include, for example, a wedge-shaped structure, and a lower surface 119d of the wedge-shaped structure protrudes below the first support member 116 or retracted into the first slot 116d. In FIG. 3A, when the compressible/stretchable member 115 is unstressed, the foot pad 119 protrudes below the free end of the first support member 116 to provide the required support force for the keyboard 100. In FIG. 3B, when the compressible/stretchable member 115 is stressed, the foot pad 119 retracts inward and is accommodated in the first slot 116d of the first support member 116 to provide the required buffering force for the keyboard 100.

Referring to FIG. 3C, the sliding member 114a may include a first inner side surface 114s1 and a first stopper 120a protruding from the first inner side surface 114s1. The sliding member 114a may also include a second inner side surface 114s2 and a second stopper 120b protruding from the second inner side surface 114s2. The first stopper 120a and the second stopper 120b protrude from opposite sides of the sliding member 114a, respectively. Furthermore, the first outer plate 116a includes a first limiting hole 121a, and the second outer plate 116b includes a second limiting hole 121b. The first limiting hole 121a is recessed in the bottom of the first outer plate 116a and is axially compatible with the first stopper 120a, allowing the first stopper 120a to be inserted into the first limiting hole 121a. Furthermore, the second limiting hole 121b is recessed in the bottom of the second outer plate 116b and is axially compatible with the second stopper 120b, allowing the second stopper 120b to be inserted into the second limiting hole 121b.

Referring to FIGS. 3A to 3C, the first limiting hole 121a and the second limiting hole 121b have a first dimension W1 in the sliding direction of the first sliding portion 114, while the first stopper 120a and the second stopper 120b have a second dimension W2 in the sliding direction of the first sliding portion 114. The second dimension W2 is smaller than the first dimension W1, for example, the second dimension W2 is approximately half of the first dimension W1, or another suitable ratio. Therefore, the first stopper 120a and the second stopper 120b can move within the first limiting hole 121a and the second limiting hole 121b, respectively, allowing the sliding member 114a to be extended and retained relative to the first support member 116 through the cooperation of the compressible/stretchable member 115 and the aforementioned limiting structure, thereby increasing the buffering stroke of the foot pad 119.

In one embodiment, the foot pad 119, through the aforementioned compressible/stretchable member 115, provides a back-and-forth buffering stroke greater than 1 mm, for example, between 1 mm and 2 mm. Compared to conventional foot pads, which are relatively hard and have a limited compressible stroke, the foot stand structure 110 of this embodiment provides a softer buffering effect and a greater buffering stroke when the entire keyboard base 106 needs to move up and down a greater stroke (e.g., greater than 1 mm) in response to impact forces, thereby achieving a soft and bouncy pressing feel.

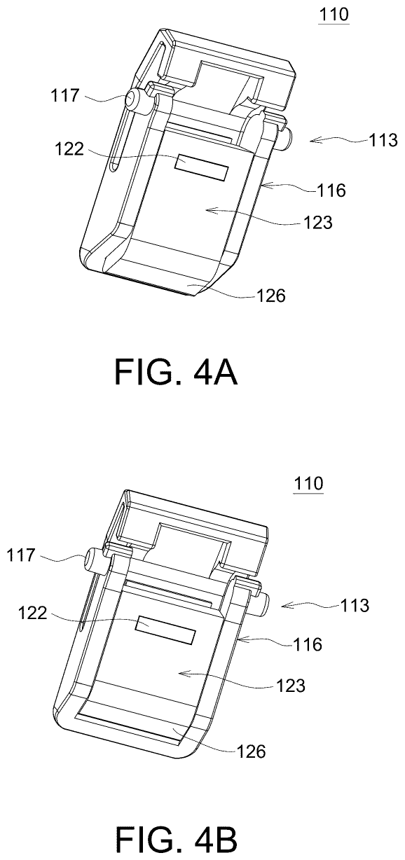

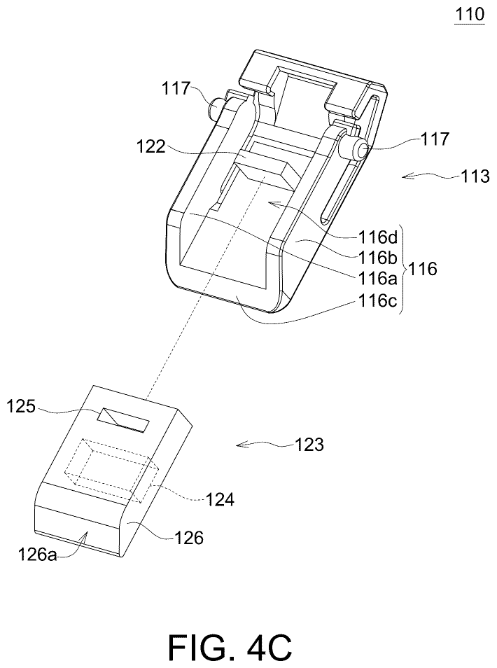

Referring to FIGS. 4A to 4C, the assembled views of the foot stand structure 110 in uncompressed and compressed states, and an exploded schematic view of the components thereof according to one embodiment of the present invention are respectively illustrated. The foot stand structure 110 includes a first support portion 113 and a first compressible/stretchable portion 123, and the first compressible/stretchable portion 123 may be a compressible resilient material. The compressible resilient material may include, but is not limited to, a hollow portion 124 recessed within the first compressible/stretchable portion 123. The compressible resilient material may be, for example, an elastic foam having a square-shaped hollow portion 124 or a hollow portion 124 of other suitable dimensions. In FIG. 4A, when the first compressible/stretchable portion 123 is unstressed, the hollow portion 124 is uncompressed, and the compressible resilient material is in a resilient state. In FIG. 4B, when the first compressible/stretchable portion 123 is stressed, the hollow portion 124 is compressed, and the compressible resilient material is in a compressed state.

Referring to FIG. 4C, the first support portion 113 includes a first support member 116 and a first rotational shaft 117 protruding outward from opposite ends of the first support member 116. The first rotational shaft 117 can be inserted into the first pivot holes 108 shown in FIG. 1B, so that the first support portion 113 is accommodated in the first mounting slot 107 shown in FIG. 1B and can be rotated relative to the keyboard base 106 to an open position (as shown in FIG. 5). In one embodiment, when the keyboard 100 is not supported by the foot stand structure 110, the foot stand structure 110 can be folded and stored in the first mounting slot 107.

Referring to FIG. 4C, the first support member 116 has a first slot 116d and a first positioning member 122 disposed within the first slot 116d. The first support member 116, for example, has a U-shaped structure, including the first slot 116d defined by three inner walls of the U-shaped structure: a first outer plate 116a, a second outer plate 116b, and a lower plate 116c. The first positioning member 122, for example, is disposed on the lower plate 116c and is substantially perpendicular to the lower plate 116c. In this embodiment, the first positioning member 122 is located near the pivot end (upper end) of the first support member 116 adjacent to the first rotation shaft 117 and away from the free end (lower end) of the first support member 116.

In one embodiment, the first positioning member 122 is, for example, a plate, onto which the first compressible/stretchable portion 123 is mounted. Referring to FIG. 4C, the first compressible/stretchable portion 123 includes an opening 125 recessed therein. The opening 125 mates with the first positioning member 122 to position the first compressible/stretchable portion 123 within the first slot 116d.

Furthermore, the first compressible/stretchable portion 123 may further include a foot pad 126 located at the end of the first compressible/stretchable portion 123. The hollow portion 124 is, for example, located between the foot pad 126 and the first positioning member 122. The foot pad 126 may have a wedge-shaped structure, and the lower surface 126a of the wedge-shaped structure is able to protrude below the first support member 116 or retract into the first slot 116d under stress. In FIG. 4A, when the first compressible/stretchable portion 123 is unstressed, the foot pad 126 may protrude below the free end (lower end) of the first support member 116 to provide the required support force for the keyboard 100. In FIG. 4B, when the first compressible/stretchable portion 123 is stressed, the foot pad 126 may retract inward and be accommodated in the first slot 116d of the first support member 116 to provide the required buffering force for the keyboard 100, thereby increasing the buffering travel of the foot pad 119.

In one embodiment, the foot pad 126 can provide a back-and-forth buffering stroke greater than 1 mm, for example, between 1 mm and 2 mm, through the aforementioned compressible resilient material. Compared to conventional foot pads, which are relatively hard and have a limited compressible stroke, the foot stand structure 110 of this embodiment can provide a softer buffering effect and a greater buffering stroke when the entire keyboard base 106 needs to move up and down a larger stroke (for example, greater than 1 mm) in response to an impact force, thereby achieving a soft and resilient pressing feel.

FIGS. 5 and 6 respectively illustrate side views of a keyboard according to one embodiment of the present invention. Referring to FIG. 5, the foot stand structure 110 of the keyboard 100 is tilted and supported between the keyboard base 106 and the desktop D. The foot pad 119 (or 126) of the foot stand structure 110 is used to provide the required support and buffering force for the keyboard 100, thereby reducing the noise generated by vibration waves transmitted to the keyboard base 106. In FIG. 5, the force (pressing force) acting in the pressing direction X1 of the key 102 and the force (buffering force) acting in the compression and rebound direction X2 of the foot pad 119 (or 126) are not aligned, but rather form an angle θ therebetween, for example, an acute angle less than 45 degrees. In other words, the pressing direction X1 of the key 102 and the compression and rebound direction X2 of the foot pad 119 (or 126) intersect at an acute angle, thereby adjusting the buffering force and direction of the foot pad 119. Referring to FIG. 6, in another embodiment, the pressing direction X1 of the key 102 and the compression and rebound direction X2 of the foot pad 119 (or 126) are substantially parallel, so that the pressing force and buffering force are substantially equal, thereby adjusting the buffering force and direction of the foot pad 119 (or 126).

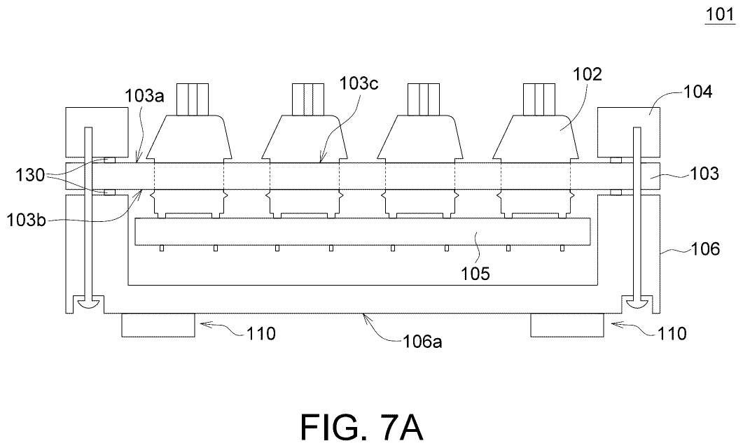

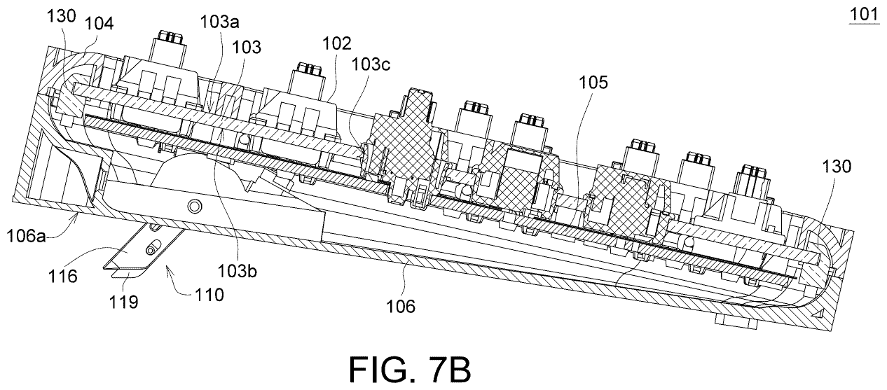

Referring to FIG. 7A and FIG. 7B, a simplified schematic view and a cross-sectional schematic view of a keyboard 101 according to another embodiment of the present invention are respectively illustrated. The keyboard 101 may include a plurality of keys 102, a middle frame 103, a keyboard cover 104, a circuit board 105, a keyboard base 106, and a foot stand structure 110. The keyboard cover 104 covers the middle frame 103, which is disposed between the keyboard cover 104 and the keyboard base 106. The middle frame 103 includes a plurality of key openings 103c, and each of the key openings 103c has an opening for one of keys 102 to move up and down relative to the middle frame 103. The keyboard base 106 supports the circuit board 105 and trigger switches (not shown) disposed between the circuit board 105 and the keys 102. When one of the keys 102 is pressed and moves downward, the trigger switch located below one of the keys 102 is turned on to generate a press signal. The keys 102 may be used in a mechanical keyboard, with each key 102 having a corresponding independent micro-switch (also known as a mechanical switch). Generally speaking, the tactile feel of mechanical switches can be roughly divided into two categories: step-by-step switches (also known as segmented switches) and linear switches. Step-by-step switches create a “step-by-step” actuation process, meaning that when pressing a certain position, you feel a sudden increase in resistance, followed by a return to the previous low resistance until you hit the bottom. Since step-by-step switches can sense the triggering of key 102, it means that you don't need to bottom out to determine whether the key 102 has been actuated. Therefore, once the step-by-step feel is sensed, the next actuation can be performed. In addition, clicky switches, also known as two-step switches, have a tactile feel characterized by a noticeable increase and decrease in pressure when pressed, as if there is a foreign object, accompanied by a distinct clicking sound coming from the shaft. On the other hand, linear switches experience a uniform increase in pressure from the start of pressing key 102 to bottoming out, directly proportional to the travel of key 102. However, because of the straight-up and straight-down feel of the linear switches, there is no step-by-step feel during the pressing process. The difference in feel of a linear switch mainly depends on the spring's strength, length, number of turns, and other characteristics, and the linear switch may be triggered prematurely before the key 102 reaches the bottom of its travel.

In addition, referring to FIGS. 7A and 7B, the keyboard 101 may also include a shock-absorbing structure 130, which is disposed between the keyboard cover 104 and the keyboard base 106. The shock-absorbing structure 130 is, for example, a shock-absorbing pad (the figure shows the shock-absorbing structure located on both sides of the keyboard 101). The shock-absorbing structure 130 is located at the edge area of the middle frame 103 and covers the upper surface 103a and lower surface 103b of the middle frame 103, thereby maintaining a shock-absorbing space between the keyboard cover 104 and the middle frame 103 and between the keyboard base 106 and the middle frame 103. When a key 102 is pressed, a vibration wave is transmitted through the middle frame 103 below the key 102 to the edge area of the middle frame 103. The vibration wave is then absorbed by the shock-absorbing structure 130 located in the edge area thereof, preventing the vibration wave from being transmitted to the keyboard base 106 and generating noise. Furthermore, the foot stand structure 110 shown in FIGS. 2A-2C, 3A-3C, and 4A-4C can also be installed in the keyboard 101 having the shock-absorbing structure 130 in this embodiment. This can provide a softer buffering effect when the entire keyboard base 106 needs to move up and down a large stroke (e.g., greater than 1 mm) in response to an impact force, thereby achieving a soft and bouncy pressing feel.

Referring to FIGS. 7A and 7B, the foot stand structure 110 is disposed on the lower surface 106a of the keyboard base 106, and the number of stands may include, but is not limited to, two. Furthermore, the foot stand structure 110 shown in FIG. 5 and FIG. 6 may also be disposed in the keyboard 101 having the shock-absorbing structure 130 of this embodiment to provide the required support and buffering force for the keyboard 101, thereby reducing the noise generated by vibration waves transmitted to the keyboard base 106 and increasing the buffering travel of the foot pad 119 (or 126). In FIG. 5, the force (pressing force) acting in the pressing direction X1 of the key 102 and the force (buffering force) acting in the compression and rebound direction X2 of the foot pad 119 (or 126) are not aligned, and an angle θ is formed therebetween, for example, an acute angle less than 45 degrees. That is, the pressing direction X1 of the key 102 and the compression and rebound direction X2 of the foot pad 119 intersect at an acute angle, thereby adjusting the buffering force and direction of the foot pad 119 (or 126). Referring to FIG. 6, in another embodiment, the pressing direction X1 of the key 102 and the compression and rebound direction X2 of the foot pad 119 (or 126) are substantially parallel, so that the pressing force and the buffering force are substantially equal, thereby adjusting the buffering force and direction of the foot pad 119 (or 126).

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keyboard, comprising:
a keyboard base having a first mounting slot on a lower surface of the keyboard base, and first pivot holes recessed inwardly on opposite sides of the first mounting slot; and
a foot stand structure disposed on the lower surface of the keyboard base, the foot stand structure comprising a first support portion, a first sliding portion, and a compressible/stretchable member,
wherein the first support portion comprises a first support member and a first rotating shaft protruding outward from opposite ends of the first support member,
the first rotating shaft is sleeved in the first pivot holes so that the first support portion is accommodated in the first mounting slot and is rotatable relative to the keyboard base to an open position,
the first support member has a first slot and a first fixing member disposed within the first slot,
wherein the first sliding portion includes a sliding member and a first abutting member extending outward from one end of the sliding member,
the first fixing member is disposed opposite the first abutting member, and the compressible/stretchable member is disposed between the first fixing member and the first abutting member,
the sliding member is disposed in the first slot and is retractable relative to the first support member by the compressible/stretchable member.

2. The keyboard of claim 1, wherein the compressible/stretchable member comprises a compression spring, when the compressible/stretchable member is unstressed, the compressible/stretchable member is in a stretched state; when the compressible/stretchable member is stressed, the compressible/stretchable member is in a compressed state.

3. The keyboard of claim 1, wherein the compressible/stretchable member comprises a tension spring, when the compressible/stretchable member is unstressed, the compressible/stretchable member is in a compressed state; when the compressible/stretchable member is stressed, the compressible/stretchable member is in a stretched state.

4. The keyboard of claim 1, wherein the first sliding portion comprises a foot pad located at another end of the sliding member, when the compressible/stretchable member is unstressed, the foot pad protrudes below the first support member; when the compressible/stretchable member is stressed, the foot pad retracts inward and is accommodated in the first slot of the first support member.

5. The keyboard of claim 4, wherein the foot pad comprises at least one inner plate and at least one stopper protruding from the inner plate, and the first support member comprises at least one outer plate and at least one limiting hole in the outer plate, the limiting hole passing through the outer plate and axially compatible with the stopper, allowing the stopper to be inserted into the limiting hole.

6. The keyboard of claim 5, wherein the limiting hole has a first dimension in a sliding direction of the first sliding portion, and the stopper has a second dimension in the sliding direction of the first sliding portion, the second dimension is smaller than the first dimension, so that the foot pad is retractable in the sliding direction of the first sliding portion.

7. The keyboard of claim 4, wherein the sliding member includes at least one inner side surface and at least one stopper protruding from the inner side surface, and the first support member includes at least one outer plate and at least one limiting hole located in the outer plate, the limiting hole is recessed in the outer plate and axially compatible with the stopper, allowing the stopper to be inserted into the limiting hole.

8. The keyboard of claim 7, wherein the limiting hole has a first dimension in a sliding direction of the first sliding portion, and the stopper has a second dimension in the sliding direction of the first sliding portion, the second dimension is smaller than the first dimension, so that the foot pad is retractable in the sliding direction of the first sliding portion.

9-12. (canceled)

13. A foot stand structure, comprising:
a first support portion, comprising a first support member and a first rotational shaft protruding outward from opposite ends of the support member, the first rotational shaft being sleeved within pivot holes of a base to enable the first support portion to rotate relative to the base to an open position;
a first sliding portion disposed within the first support member; and
a compressible/stretchable member disposed between the first support member and the first sliding portion, the first sliding portion being retractable relative to the first support member by the compressible/stretchable member.

14. The foot stand structure of claim 13, wherein the compressible/stretchable member comprises a compression spring, when the compressible/stretchable member is unstressed, the compressible/stretchable member is in a stretched state; when the compressible/stretchable member is stressed, the compressible/stretchable member is in a compressed state.

15. The foot stand structure of claim 13, wherein the compressible/stretchable member comprises a tension spring, when the compressible/stretchable member is unstressed, the compressible/stretchable member is in a compressed state; when the compressible/stretchable member is stressed, the compressible/stretchable member is in a stretched state.

16. The foot stand structure of claim 13, wherein the compressible/stretchable member comprises a hollow portion within a compressible/stretchable portion, the first compressible/stretchable portion is compressible/stretchable relative to the first support member via the hollow portion.

17. The foot stand structure of claim 16, wherein when the first compressible/stretchable portion is in an unstressed state, the hollow portion is not compressed; when the first compressible/stretchable portion is in a stressed state, the hollow portion is compressed.

18. The foot stand structure of claim 16, wherein the compressible resilient portion comprises elastic foam.

19. The foot stand structure of claim 16, wherein the first support member has a first slot and a first positioning member disposed within the first slot, and the first compressible/stretchable portion is fixed to the first slot by the first positioning member.

20. The foot stand structure of claim 19, wherein a distal end of the first compressible/stretchable portion includes a foot pad, and the hollow portion is located between the foot pad and the first positioning member.
